(19) United States
(12) Patent Application Publication
(10) Pub. No.: US 2013/0161048 A1
(43) Pub. Date: Jun. 27, 2013

(54) POWER TOOL

(71) Applicant: MAKITA CORPORATION, Anjo-shi (JP)

(72) Inventor: Shinji HIRABAYASHI, Anjo-shi (JP)

(73) Assignee: MAKITA CORPORATION, Anjo-shi (JP)

(21) Appl. No.: 13/715,411

(22) Filed: Dec. 14, 2012

(30) Foreign Application Priority Data
Dec. 22, 2011 (JP) 2011-282299

(51) Int. Cl. B25F 5/00; B25B 23/147; B23B 45/00; B25B 21/00

(52) U.S. Cl. CPC B25F 5/001; B25B 21/00; B25B 23/147; B23B 45/008
USPC 173/176; 475/317; 475/149; 475/153; 173/216

(57) ABSTRACT

An electric driver (1) as a power tool comprises a motor (2) which actuates a tool bit (100). The electric driver (1) has a first planetary gear mechanism (30), a second planetary gear mechanism (40), and a regulation member which regulate a second outer gear (43) to rotate. The regulation member includes an outer gear engaging member (50) and a deformable member (51) which is fixedly connected to the outer gear engaging member (50). The deformable member (51) extends in a direction in which a rotational axis of the first and the second planetary gear mechanism (30, 40) extends. A controller (61) is adapted to measure rotation torque based on displacement of the deformable member (51) via a strain gauge (55) which is attached on the deformable member (51).

### CROSS REFERENCE TO RELATED APPLICATION

The present application claims priority from Japanese Patent Applications No. 2011-282299 filed on Dec. 22, 2011, the disclosure of which is incorporated herein by reference in its entirety.

### FIELD OF THE INVENTION

The invention relates to a power tool which actuate a tool.

### BACKGROUND OF THE INVENTION

Japanese Unexamined Patent Application Publication No. H06-254775 discloses an electric rotational power tool having a torque detection device. The torque detection device detects a torque value based on displacement of a rocking detecting piece detected by a strain gauge. The rocking detecting piece is connected to an internal gear via a steel ball. The ball is pressed by a coil spring and thereby the rotatably held internal gear is regulated to rotate by the ball engaging with a roller which is inserted in a peripheral groove of the internal gear. Accordingly, a clutch in which the roller climbs over the ball and thereby the internal gear can rotate when the torque value exceeds a predetermined value, is constituted.

### SUMMARY OF THE INVENTION

### Problem to be Solved by the Invention

According to the toque detection device, the internal gear and the rocking detecting piece are connected to each other via the roller and the ball which are rotatable. However, since said rotatable member is provided between the internal gear and the rocking detecting piece, it may be possible to reduce a precision of the torque value detected by the torque detection device.

An object of the invention is, in consideration of the above described problem, to provide an improved technique to detect torque loaded on a tool of a power tool.

### Means for Solving the Problem

Above-mentioned object is achieved by the claimed invention. According to a preferable aspect of the invention, a power tool which is adapted to actuate a tool, comprises a driving mechanism, a planetary gear mechanism which includes a sun gear, a planetary gear, an outer gear and a planetary carrier, a regulation member which regulates a rotation of the outer gear, and a measurement mechanism which measures rotation torque exerted on the tool. The regulation member includes a first member and a second member which connects fixedly to the first member, the first member being engageable with the outer gear. The second member is disposed so as to extend from a connecting point at which the first member and the second member are connected to each other in a direction in which a rotational axis of the planetary gear mechanism extends. Further, the measurement mechanism is adapted to measure rotation torque based on displacement of the second member.

According to this aspect, since the first member and the second member of the regulation member are fixedly connected to each other, the measurement mechanism measures displacement of the second member precisely. In other words, since no component is provided between the regulation member and the outer gear, namely the first member is engaged with the outer gear directly, rotation torque based on displacement of the second member is measured precisely.

According to a further preferable aspect of the invention, the power tool further comprises a rolling bearing which is disposed on an outer surface of the outer gear. Further, the outer gear is rotatably held by the rolling bearing.

According to this aspect, by holding the outer gear rotatably, rotation torque based on displacement of the second member is measured.

According to a further preferable aspect of the invention, the planetary gear mechanism includes a first planetary gear mechanism which is disposed at a driving mechanism side and a second planetary gear mechanism which is disposed at a tool side. Further, the regulation member is adapted to regulate a rotation of an outer gear of the second planetary gear mechanism.

According to this aspect, since the regulation member engages with the second planetary gear mechanism which is disposed at the tool side, rotation torque exerted on the tool during an operation to a workpiece is measured precisely.

According to a further preferable aspect of the invention, the second member is fixed on the driving mechanism or a component which holds the driving mechanism.

According to this aspect, since the second member is fixed on the driving mechanism or the component which holds the driving mechanism, the measurement mechanism measures rotation torque precisely by measuring displacement of the second member which has a fixed end defined by such fixed portion.

According to a further preferable aspect of the invention, the power tool further comprises a controller which controls the driving mechanism. The controller is adapted to stop a driving of the driving mechanism in a state that rotation torque measured by the measurement mechanism exceeds a predetermined torque.

According to this aspect, since the controller stops a driving of the driving mechanism based on rotation torque which is measured by the measurement mechanism, rotation toque exerted on a workpiece via the tool is controlled. Further, by stopping the driving of the driving mechanism, an inadvertent toque occurred on an intermediate component such as the tool or the planetary gear mechanism is regulated.

According to a further preferable aspect of the invention, the power tool is configured as a screw driver. Further, the controller is adapted to stop a driving of the driving mechanism in a state that rotation torque measured by the measurement mechanism exceeds a predetermined fastening torque.

According to this aspect, since the power tool is configured as a screw driver, a tightening torque in a screw tightening operation is controlled.

According to a further preferable aspect of the invention, the power tool is configured as a drill which performs a drill operation on a workpiece.

According to this aspect, since the power tool is configured as a drill which performs a drill operation, an inadvertently rotation of a main body of the drill during the drill operation is regulated. Namely, when the tool bites a workpiece during the drill operation, the tool cannot rotate. However, in such situation, since the driving mechanism is still driving, large rotation torque which exceeds holding force of a user is occurred on the main body of the drill and thereby it may be possible that the main body is inadvertently rotated. However, according to this aspect, in a state that the tool bites a workpiece and large rotation torque which exceeds a predetermined torque is measured by the measurement mechanism, a driving of the driving mechanism is stopped. Therefore, such inadvertent rotation of the main body of the drill is regulated.

According to a further preferable aspect of the invention, the driving mechanism includes a motor which actuates the planetary gear mechanism and an operated member which controls a current provision to the motor. Further, at least a part of the second member is disposed between the planetary gear mechanism and the operated member.

According to this aspect, since the second member is disposed between the planetary gear mechanism and the operated member, the second member is protected. Namely, since rotation torque is measured by the measurement mechanism based on displacement of the second member, when an internal force is exerted on the second member and the second member is deformed by the internal force, rotation torque is not measured precisely. However, according to this aspect, since the second member is surrounded by the planetary gear mechanism and the operated member, the second member is protected from an internal force. Therefore, the second member is regulated to be deformed or damaged by an inadvertently external force exerted on the second member.

According to a further preferable aspect of the invention, the power tool further comprises a grip which is held by a user. The grip is disposed such that a direction in which the grip extends crossed a direction of the rotational axis of the planetary gear mechanism.

According to this aspect, since the direction in which the grip extends crosses the direction of the rotational axis of the planetary gear mechanism, a user can hold the power tool easily. Further, a space for the second member is provided between the planetary gear mechanism and the operated member and thereby each component is rationally arranged.

Accordingly, an improved technique to detect torque loaded on a tool of the power tool is provided.

Other objects, features and advantages of the invention will be readily understood after reading the following detailed description together with the accompanying drawings and the claims.

### BRIEF DESCRIPTION OF THE DRAWINGS

FIG. 1 shows a side view of a total composition of an electric driver according to a representative embodiment of the invention.

FIG. 2 shows a front view of the electric driver.

FIG. 3 shows a side view of an inner composition of the electric driver.

FIG. 4 shows a partial cross-sectional view taken from line IV-IV of FIG. 1.

FIG. 5 shows a cross-sectional view taken from line V-V of FIG. 1.

FIG. 6 shows a cross-sectional view taken from line VI-VI of FIG. 1.

### DESCRIPTION OF THE PREFERRED EMBODIMENTS

Each of the additional features and method steps disclosed above and below may be utilized separately or in conjunction with other features and method steps to provide and manufacture improved power tools and method for using such the power tools and devices utilized therein. Representative examples of the invention, which examples utilized many of these additional features and method steps in conjunction, will now be described in detail with reference to the drawings. This detailed description is merely intended to teach a person skilled in the art further details for practicing preferred aspects of the present teachings and is not intended to limit the scope of the invention. Only the claims define the scope of the claimed invention. Therefore, combinations of features and steps disclosed within the following detailed description may not be necessary to practice the invention in the broadest sense, and are instead taught merely to particularly describe some representative examples of the invention, which detailed description will now be given with reference to the accompanying drawings.

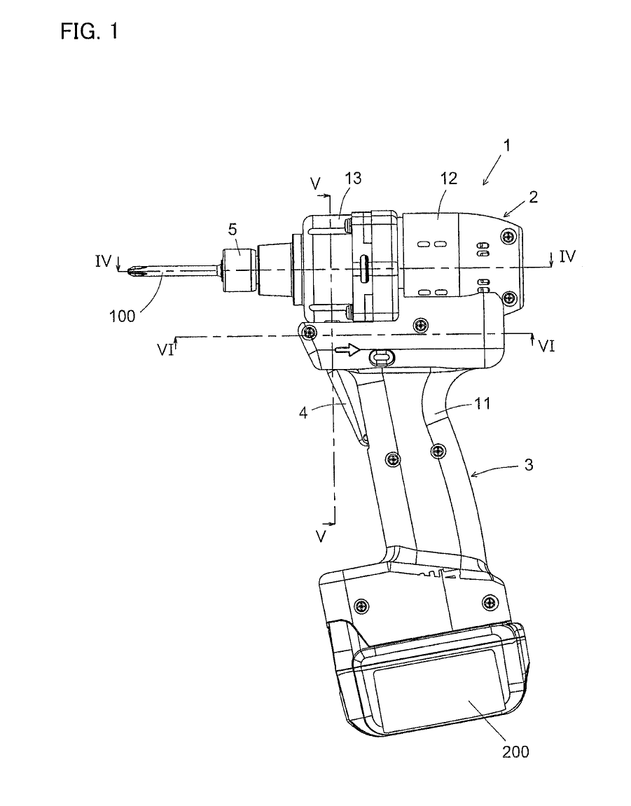

A representative embodiment of the invention will be explained with reference to FIG. 1 to FIG. 6. This embodiment is one example in which the invention is applied to an electric driver as a power tool.

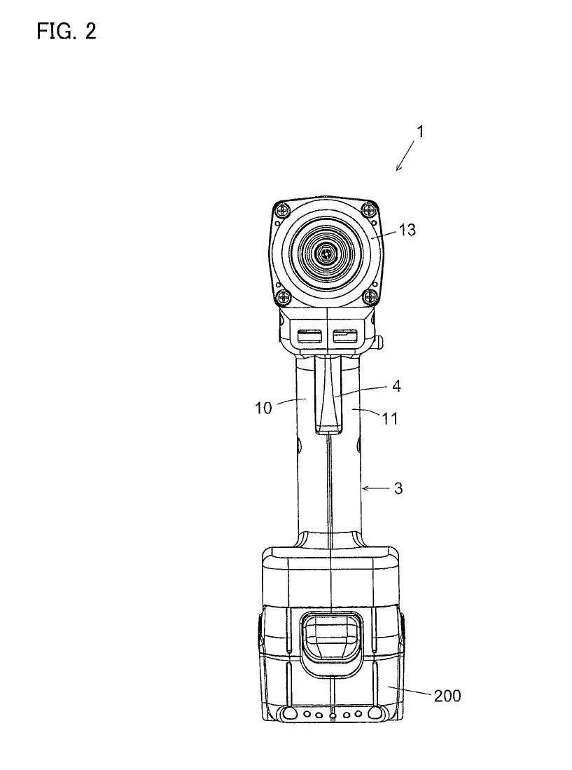

As shown in FIG. 1 and FIG. 2, the electric driver 1 is mainly provided with a driving part 2, a grip portion 3, a trigger 4, and a tool holder 5. A tool bit 100 and a battery 200 are detachably attached to the electric driver 1. The electric driver 1 is one example corresponding to “a screw driver” of the invention. Further, the tool bit 100 is one example corresponding to “a tool” of the invention.

The electric driver 1 comprises a left housing 10, a right housing 11, a motor housing 12 and a gear housing 13, and each components of the electric driver 1 are disposed in an inner space formed by these housings.

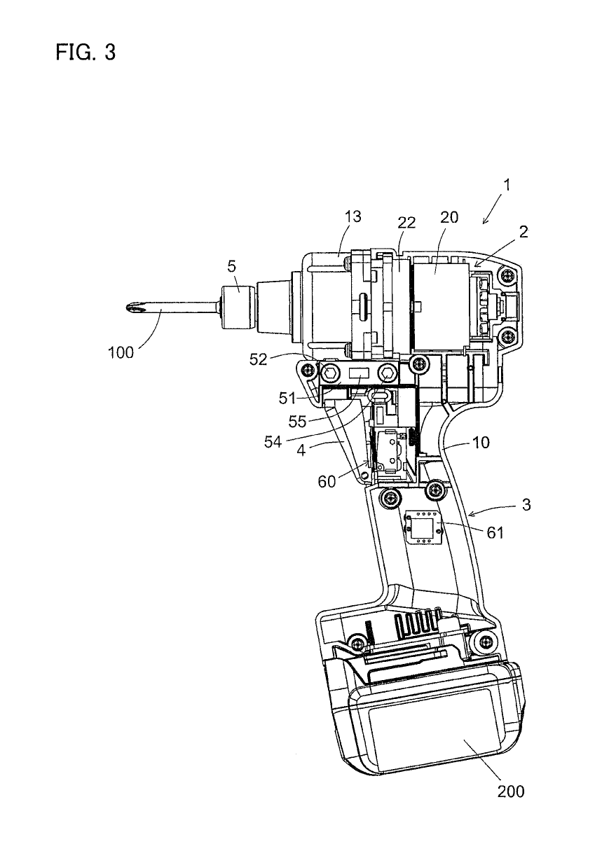

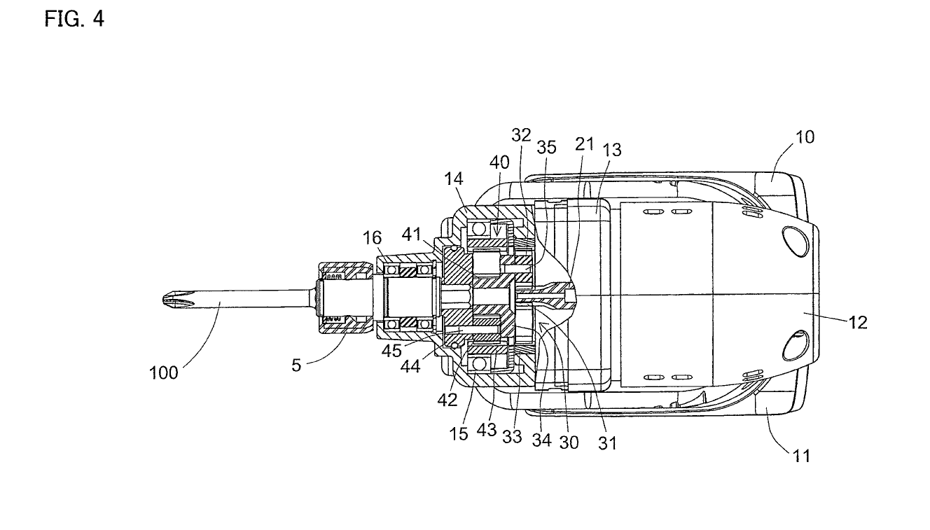

As shown in FIG. 3 and FIG. 4, a motor 20 is disposed at an upper side of the left housing 10. The motor 20 is housed in an inner space which is formed by the left housing 10 and the motor housing 12 by fixing the motor housing 12 on the left housing 10 by means of a plurality of screws as shown in FIG. 1. The motor 20 is disposed such that a rotational shaft 21 is protruded toward the gear housing 13. The motor 20 constitutes the driving part 2. The driving part 2 is one example corresponding to “a driving mechanism” of the invention.

As shown in FIG. 3, a switch circuit 60 and a controller 61 are disposed below the motor 20. Further, as shown in FIG. 1, by fixing the left housing 10 and the right housing 11 to each other by means of a plurality of screws, the switch circuit 60 and the controller 61 are disposed in an inner space formed by the left housing 10 and the right housing 11. A trigger 4 is disposed closely to the switch circuit 60. The left housing 10 and the right housing 11 constitute the grip portion 3 which is held by a user. The grip portion 3 extends in a vertical direction in FIG. 1. The grip portion 3 is one example corresponding to “a grip” of the invention.

As shown in FIG. 3, the battery 200 is detachably attached at a lower end of the left housing 10. By operating the trigger 4, the switch circuit 60 controls a current from the battery 200 to the motor 20.

As shown in FIG. 4, the gear housing 13 houses the inner housing 14. The inner housing 14 houses a first planetary gear mechanism 30 and a second planetary gear mechanism 40 and so on. The first planetary gear mechanism 30 and the second planetary gear mechanism 40 are disposed such that the rotational shaft 21 extends in a lateral direction in FIG. 1 and crosses a direction in which the grip portion 3 extends.

As shown in FIG. 4, the first planetary gear mechanism 30 is mainly provided with a first sun gear 31, a first planetary gear 32, a first outer gear 33, a first planetary carrier 34, and a connection pin 35. In particular, the first sun gear 31 is disposed at a distal end of the rotational shaft 21. Three first planetary gears 32 which engage with the first sun gear 31 are disposed on a periphery of the first sun gear 31. Further, the first outer gear 33 which engages with said three first planetary gears 32 respectively is disposed on a periphery of said three first planetary gears 32. The first outer gear 33 is fixed against the inner housing 14. Further, said three first planetary gears 32 are connected to the first planetary carrier 34 via the connection pins 35 respectively.

As to the first planetary gear mechanism 30 described above, rotation of the rotational shaft 21 is transmitted to said three first planetary gears 32 and thereby the first planetary gear 32 is rotated around the first sun gear 31. Therefore, the first planetary carrier 34 which is connected to the first planetary gear 32 is rotated. Namely, rotational velocity of the rotational shaft 21 is reduced and the first planetary carrier 34 is rotated at the reduced rotational velocity. The first planetary gear mechanism 30 is one example corresponding to “a first planetary gear mechanism” of the invention.

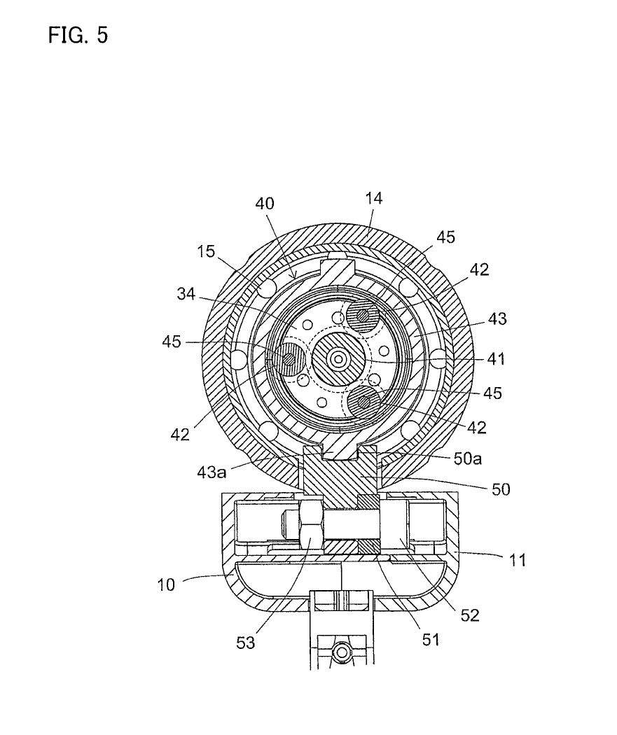

As shown in FIG. 4 and FIG. 5, the second planetary gear mechanism 40 is mainly provided with a second sun gear 41, a second planetary gear 42, a second outer gear 43, a second planetary carrier 44, and a connection pin 45. In particular, the second sun gear 41 is disposed on the first planetary carrier 34. Three second planetary gears 42 which engage with the second sun gear 41 are disposed on a periphery of the second sun gear 41. Further, the second outer gear 43 which engages with said three second planetary gears 42 respectively is disposed on a periphery of said three second planetary gears 42. The second outer gear 43 is rotatably supported against the inner housing 14 via a ball bearing 15 which is disposed on a periphery of the second outer gear 43. The second outer gear 43 engages with an outer gear engaging member 50 and thereby a rotation of the second outer gear 43 against the inner housing 14 is regulated. Further, said three second planetary gears 42 are connected to the second planetary carrier 44 via the connection pins 45 respectively. The bearing 15 is one example corresponding to “a rolling bearing” of the invention.

As to the second planetary gear mechanism 40 described above, a decelerated rotation of the rotational shaft 21 is transmitted to the second sun gear 41 via the first planetary carrier 34, the decelerated rotation being decelerated by the first planetary gear mechanism 30. Said three second planetary gears 42 are rotated around the second sun gear 41 by rotation of the second sun gear 41. Therefore, the second planetary carrier 44 which is connected to the second planetary gear 42 is rotated. Namely, the decelerated rotation of the rotational shaft 21, which is decelerated by the first planetary gear mechanism 30, is further decelerated and thereby the second planetary carrier 44 is rotated by the further decelerated rotation. The second planetary gear mechanism 40 is one example corresponding to “a second planetary gear mechanism” of the invention. Further, a speed reduction mechanism including the first planetary gear mechanism 30 and the second planetary gear mechanism 40 is one example corresponding to “a planetary gear mechanism” of the invention.

As shown in FIG. 4, the second planetary carrier 44 is connected to the tool holder 5. In particular, the tool holder 5 is rotatably supported against the inner housing 14 via two bearings 16. One end of the tool holder 5 is connected to the second planetary carrier 44 and thereby the tool holder 5 is rotated integrally with the second planetary carrier 44. Further, the tool bit 100 is detachably attached to the other end of the tool holder 5.

As shown in FIG. 5, an outer gear engaging member 50 is adapted to regulate a rotation of the second outer gear 43, and is disposed at a lower region of the second outer gear 43. The outer gear engaging member 50 has an engagement recess 50a which engages with an engagement protrusion 43a formed on the second outer gear 43. A distal end of the outer gear engaging member 50, which is opposite to the engagement recess 50a, is connected to a deformable member 51. The outer gear engaging member 50 and the deformable member 51 are fixedly connected to each other by means of a bolt 52 and a nut 53. The outer gear engaging member 50 is one example corresponding to “a first member” of the invention.

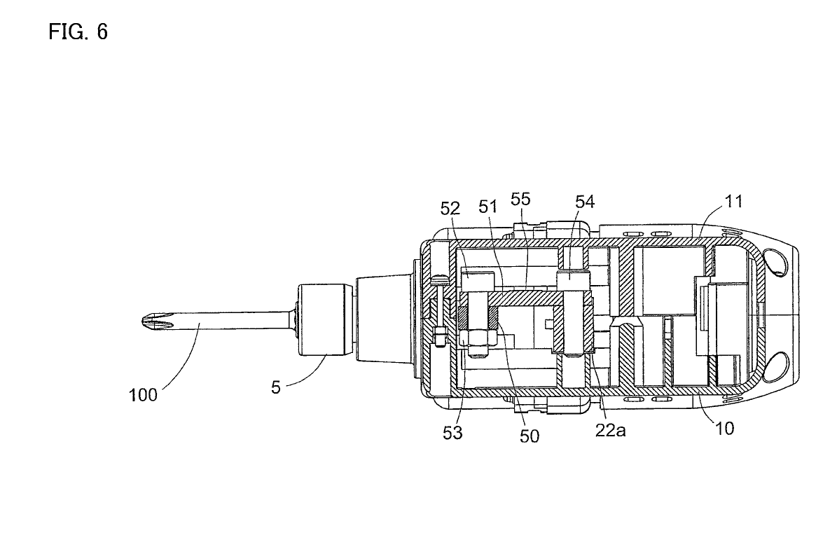

As shown in FIG. 3 and FIG. 6, the deformable member 51 is disposed such that a longitudinal direction of the deformable member 51 is in conformity with a direction of a rotational axis of the first planetary gear mechanism 30 and the second planetary gear mechanism 40 as well. Further, the deformable member 51 has a rectangular section in a section crossing the longitudinal direction. A distal end of the deformable member 51, which is opposite to another end connecting to the outer gear engaging member 50, is fixed on an engagement portion 22a which is formed on a housing portion 22 of the motor 20 by means of a bolt 54. Therefore, the deformable member 51 is disposed as a cantilever in which the distal end fixed on the housing 22 is defined as a fixed end. The deformable member 51 is one example corresponding to “a second member” of the invention. Further, a component which includes both of the outer gear engaging member 50 and the deformable member 51 is one example corresponding to “a regulation member” of the invention. The outer gear engaging member 50 and the deformable member 51 are disposed between the planetary gear mechanism 30, 40 and the trigger 4.

As shown in FIG. 3, a strain gauge 55 is attached on a side surface of the deformable member 51 along the longitudinal direction of the deformable member 51. Further, the strain gauge 55 is electrically connected to a controller 61.

The controller 61 is mainly provided with a CPU (Central Processing Unit), a ROM (Read Only Memory) in which a program and a data which are adapted to control the electric driver 1 is stored, and a RAM (Random Access Memory) which stores temporally data processed by the CPU. The controller 61 detects a current value of the strain gauge 51. Further, the controller 61 calculates a change of an electric resistance of the strain gauge 51 based on the detected current value, and then derives deformation of the deformable member 51. Further, the controller 61 controls current form the battery 200 to the motor 20 in accordance with the detected current value.

Regarding the electric driver 1 described above, when the trigger 4 is pulled, current is provided to the motor 20 from the battery 200. Speed of rotation torque of the rotational shaft 21 is decelerated by the first planetary gear mechanism 30 and the second planetary gear mechanism 40, and then rotation torque with decelerated speed is transmitted to the tool holder 5. Therefore, the tool bit 100 held by the tool holder 5 is rotated, and thereby a screw tightening operation is performed.

When the motor 20 is driven, rotation torque is transmitted to the second outer gear 43 of the second planetary gear mechanism 40. The second outer gear 43 is rotatably supported by the bearing 15, however the second outer gear 43 is regulated to rotate by the outer gear engaging member 50 which engages with the second outer gear 43. Namely, each side surface of the engagement protrusion 43a of the second outer gear 43 and the engagement recess 50a of the outer gear engaging member 50 are contacted to each other, and the outer gear engaging member 50 is inclined to move leftward in FIG. 5, however the outer gear engaging member 50 is regulated to move due to a bending stiffness itself. As a result, a rotation of the second outer gear 43 is regulated. In this way, the tool bit 100 is actuated and thereby the screw tightening operation is performed on a workpiece. Further, at this time, a connecting side of the deformable member 51, which is connected to the outer gear engaging member 50, is moved in a direction in which a short side of the rectangular section extends, thereby the deformable member 51 is deformed.

In case that rotation torque is exerted on the second outer gear 43, the connecting side of the deformable member 51 is displaced downward in FIG. 5 against the fixed end. A strain caused by such displacement of the deformable member 51 changes the electric resistance of the strain gauge 55 which is attached on the side surface (upper surface in FIG. 6) on which tension force is exerted of the deformable member 51. At this time, the controller 61 detects a current value of the strain gauge 55 and then calculates displacement of the deformable member 51 based on the change of the current value. Further, the controller 61 calculates rotation torque exerted on the second outer gear 43 based on displacement of the deformable member 51. A component including both of the strain gauge 55 and the controller 61 is one example corresponding to “a measurement mechanism” of the invention.

A predetermined tightening torque which is set in the controller 61 is adjustable by a user, and in case that rotation toque calculated by the controller 61 based on the current value of the strain gauge 55 exceeds the predetermined tightening torque, the controller 61 interrupts current to the motor 20. Namely, in case that the tightening torque of the tool bit 100 which is substantially equal to the rotation torque exerted on the second outer gear 43 exceeds the predetermined tightening torque, the controller 61 interrupts current to the motor 20. Therefore, the tightening torque in the screw tightening operation is controlled. The controller 61 is one example corresponding to “a controller” of the invention.

According to the embodiment described above, since the outer gear engaging member 50 which is fixed on the deformable member 51 directly engages with the second outer gear 43, the deformation of the deformable member 51 is detected precisely via the strain gauge 55. At this time, both of the side surfaces of the engagement protrusion 43a of the second outer gear 43 and the engagement recess 50a of the outer gear engaging member 50 are contacted to each other in a plane contact or a line contact manner, therefore torsional deformation of the deformable member 51 is regulated. Accordingly, deformation of the deformable member 51 is precisely measured via the strain gauge 55 by regulating the torsional deformation.

Further, according to the embodiment, since the deformable member 51 is disposed such that the longitudinal direction of the deformable member 51 is line with the direction of the rotational axis of the first planetary gear mechanism 30 and the second planetary gear mechanism 40 as well, a size of the electric driver 1 is regulated to expand in a radial direction of the planetary gear mechanism 30, 40 in terms of an arrangement of the deformable member 51.

The displacement of the distal end at which the deformable member 51 as a cantilever engages with the outer gear engaging member 50 is proportional to the length and is inversely proportional to the bending stiffness of the cantilever. Further, for the purpose of precisely measuring the deformation of the deformable member 51, it is preferable that deformation of the deformable member 51 is larger. Therefore, in the embodiment, by providing the deformable member 51 such that the longitudinal direction of the deformable member 51 is in conformity with the direction of the rotational axis of the first planetary gear mechanism 30 and the second planetary gear mechanism 40, it is not only the electric driver 1 is regulated to become larger but also the length of the deformable member 51 is provided longer. Therefore, in comparison with a construction in which the length of the deformable member is shorter, displacement of the distal end of the deformable member 51 is larger. As a result, since deformation is larger, deformation of the deformable member 51 as a cantilever is precisely measured.

Further, the deformable member 51 deforms in the direction in which the short side of the rectangular section extends, the rectangular section crossing the longitudinal direction of the deformable member 51. Namely, in the cross section, the deformable member 51 deforms in a lower bending stiffness direction. Therefore, deformation of the deformable member 51 is larger. As a result, in comparison with a construction in which deformation is lesser, deformation of the deformable member 51 is precisely measured.

Further, according to the embodiment, the deformable member 51 on which the strain gauge 55 is attached is arranged between the planetary gear mechanisms 30, 40 and the trigger 4. Since the electric driver 1 is portable, while the electric driver 1 is carried by a user, it may be possible that a user inadvertently drops the electric driver 1. Even in such case that the electric driver 1 is dropped, since the deformable member 51 configured to measure the rotation torque is arranged between the planetary gear mechanisms 30, 40 and the trigger 4, the deformable member 51 is protected by such components and regulated to be damaged.

Further, according to the embodiment, since the deformable member 51 is arranged between the planetary gear mechanisms 30, 40 and the trigger 4, components of the electric drive 1 are rationally arranged and thereby the electric driver 1 is regulated to become larger. Namely, in a construction in which the grip portion 3 extends such that a direction in which the grip portion 3 extends crosses the direction of the rotational shaft of the planetary gear mechanisms 30, 40, if the trigger 4 is arranged closely to the planetary gear mechanisms 30, 40, it is hard to operate the trigger 4 for a user while holding the grip portion 3. Namely, it is preferable that the trigger 4 is arranged at which a user can operate by his/her finger while holding the grip portion 3. Therefore, it may be possible that a space especially between the planetary gear mechanisms 30, 40 and the trigger 4 becomes dead space easily. However, in the embodiment, since the deformable member 51 is arranged between the planetary gear mechanisms 30, 40 and the trigger 4, the dead space is utilized effectively and the electric driver 1 is regulated to become larger. Further, at least a part of the deformable member 51 may be arranged between the planetary gear mechanisms 30, 40 and the trigger 4.

Further, according to the embodiment, the deformable member 51 connects to the second planetary gear mechanism 40 via the outer gear engaging member 50, the second planetary gear mechanism 40 being provided closer to the tool bit 100 than the first planetary gear mechanism 30. Therefore, in comparison with a construction in which the deformable member 51 connects to the first planetary gear mechanism 40, rotation torque exerted on the tool bit 100 is measured more precisely by the deformable member 51 connected to the second planetary gear mechanism 40.

Further, a variation of the embodiment will be explained. The embodiment described above, is explained by utilizing the electric drive 1 as a power tool. However, the power tool of the invention may be applied to a power drill such as an electric drill which performs a drill operation on a workpiece.

The tool bit 100 of the power drill cannot rotate, when the tool bit 100 bites a workpiece during the drill operation. In a state that the tool bit 100 cannot rotate, the second planetary carrier 44 which is connected to the tool bit 100 cannot rotate as well. At this time, since the rotation is transmitted to the second planetary gear mechanism 40 from the motor 20, in a state that the second planetary carrier 44 cannot rotate, in comparison to being able to rotate, larger rotation torque may be exerted on the second outer gear 43. As a result, when rotation torque exerted on the second outer gear 43 exceeds a holding power of a user, a body of the power drill is inadvertently rotated around the tool bit 100 bitten in a workpiece.

According to the variation, a predetermined torque is set to the power drill in advance, and when rotation torque exerted on the second outer gear 43 exceeds the predetermined torque, the controller 61 interrupts current to the motor 20. Accordingly, the inadvertent rotation of the body of the power drill is regulated during the drill operation.

In the embodiment and the variation described above, the speed reduction mechanism is provided with the first planetary gear mechanism 30 and the second planetary gear mechanism 40, however it is not limited to such planetary gear mechanism in which two planetary gear mechanisms is included. The number of the planetary gear mechanism of the speed reduction mechanism may be provided according to a necessary rotation speed and a necessary output torque, for example the speed reduction mechanism may include only one planetary gear mechanism, and on the other hand the speed reduction mechanism may include more than three planetary gear mechanisms.

Further, the controller 61 is adapted to control the tightening toque of the screw tightening operation of the electric driver 1 in the embodiment, and further the controller 61 is adapted to regulate the inadvertent rotation of the body of the power drill in the variation, however it is not limited such construction. For example, the controller 61 may be adapted as a safety mechanism which regulates a motor failure due to an overload on the motor 20. In this case, the safety mechanism may be adapted to interrupt current to the motor 20 based on the load of the motor 20.

Further, in the embodiment and the variation, the rotation torque exerted on the second outer gear 43 by measuring deformation of the deformable member 51 by means of the strain gauge 55, however it is not limited to such construction. For example, the deformable member 51 may be rotatably supported against the engagement portion 22a and rotation torque exerted on the second outer gear 43 may be measured based on displacement of the deformable member 51 caused by a rigid rotation. In this case, the strain gauge 55 may be unnecessary to be provided, on the other hand, a displacement sensor (a displacement meter) which measures displacement of the deformable member 51 may be arranged at one side of the deformable member 51 connecting to the outer gear engaging member 50.

Further, in the embodiment and the variation, the ball bearing 15 is utilized to explain as a rolling bearing of the invention, however it is not limited to such ball bearing 15. In place of the ball bearing 15, a roller and so on that may be utilized as the rolling bearing.

Further, in the embodiment and the variation, the electric driver 1 and the electric drill are utilized to explain as a power tool of the invention, however it is not limited to such electric tool. For example, a torque wrench or a grinder which is adapted to actuate a tool and so on may be utilized to the invention as the power tool.

Further, in the embodiment and the variation, the motor 20 is utilized to explain as a driving mechanism of the invention, however it is not limited to the motor 20. For example, an engine may be utilized to the invention as the driving mechanism.

Having regard to an aspect of the invention, following features are provided:

### (Feature 1)

A power tool which is adapted to actuate a tool, the power tool comprising:

a driving mechanism;

a planetary gear mechanism which includes a sun gear, a planetary gear, an outer gear, and a planetary carrier;

a regulation member which regulates a rotation of the outer gear; and

a measurement mechanism which measures rotation torque exerted on the tool,

wherein the regulation member includes a first member and a second member which connects fixedly to the first member, the first member being adapted to engage directly with the outer gear without any member between the first member and the outer gear,

wherein the second member is disposed so as to extend from a connecting point at which the first member and the second member are connected to each other in a direction in which a rotational axis of the planetary gear mechanism extends,

and wherein the measurement mechanism measures rotation torque based on displacement of the second member.

### DESCRIPTION OF NUMERALS

1 electric driver
2 driving part
3 grip portion
4 trigger
5 tool holder
10 left housing
11 right housing
12 motor housing
13 gear housing
14 inner housing
15 bearing
20 motor
21 rotational shaft
22 housing portion
22a engagement portion
30 first planetary gear mechanism
31 first sun gear
32 first planetary gear
33 first outer gear
34 first planetary carrier
35 connection pin
40 second planetary gear mechanism
41 second sun gear
   42 second planetary gear
43 second outer gear
43a engagement portion
44 second planetary carrier
45 connection pin
50 outer gear engaging member
50a engagement recess
51 deformable member
52 bolt
53 nut
54 bolt
55 strain gauge
60 switch circuit
61 controller
100 tool bit
200 battery

What is claimed is:

1. A power tool which is adapted to actuate a tool, the power tool comprising:
a driving mechanism;
a planetary gear mechanism which includes a sun gear, a planetary gear, an outer gear and a planetary carrier;
a regulation member which regulates a rotation of the outer gear; and
a measurement mechanism which measures rotation torque exerted on the tool,
wherein the regulation member includes a first member and a second member which connects fixedly to the first member, the first member being engageable with the outer gear,
wherein the second member is disposed so as to extend from a connecting point at which the first member and the second member are connected to each other in a direction in which a rotational axis of the planetary gear mechanism extends,
and wherein the measurement mechanism is adapted to measure rotation torque based on displacement of the second member.

2. The power tool according to claim 1, further comprising a rolling bearing which is disposed on an outer surface of the outer gear,
wherein the outer gear is rotatably held by the rolling bearing.

3. The power tool according to claim 1 wherein the planetary gear mechanism includes a first planetary gear mechanism which is disposed at a driving mechanism side and a second planetary gear mechanism which is disposed at a tool side,
and wherein the regulation member is adapted to regulate a rotation of an outer gear of the second planetary gear mechanism.

4. The power tool according to claim 1, wherein the second member is fixed on the driving mechanism or a component which holds the driving mechanism.

5. The power tool according to claim 1, further comprising a controller which controls the driving mechanism,
wherein the controller is adapted to stop a driving of the driving mechanism in a state that rotation torque measured by the measurement mechanism exceeds a predetermined torque.

6. The power tool according to claim 5, the power tool being configured as a screw driver,
wherein the controller is adapted to stop a driving of the driving mechanism in a state that rotation torque measured by the measurement mechanism exceeds a predetermined fastening torque.

7. The power tool according to claim 5, the power tool being configured as a drill which performs a drill operation on a workpiece.

8. The power tool according to claim 1, wherein the driving mechanism includes a motor which actuates the planetary gear mechanism and an operated member which controls a current provision to the motor,
and wherein at least a part of the second member is disposed between the planetary gear mechanism and the operated member.

9. The power tool according to claim 8, further comprising a grip which is held by a user,
wherein the grip is disposed such that a direction in which the grip extends crossed a direction of the rotational axis of the planetary gear mechanism.

10. The power tool according to claim 8, wherein the operated member is defined as a trigger which is manually operated by a user.

11. The power tool according to claim 1, wherein a strain gauge is attached on the second member,
and wherein the measurement mechanism calculates the displacement of the second member by measuring electric resistance of the strain gauge.
